(19) United States
(12) Patent Application Publication
(10) Pub. No.: US 2026/0214763 A1
(43) Pub. Date: Jul. 23, 2026

(54) CONTINUOUS MICROWAVES EXTRACTION APPARATUS WITH BELT CONVEYOR

(71) Applicant: Firmenich SA, Satigny (CH)

(72) Inventors: Sophie LAVOINE HANNEGUELLE, Grasse (FR); Joao CABRAL DA SILVA, Grasse (FR)

(21) Appl. No.: 19/137,814

(22) PCT Filed: Dec. 18, 2023
(86) PCT No.: PCT/EP23/86333

§ 371 Date: Jun. 11, 2025

(30) Foreign Application Priority Data
Dec. 19, 2022 (EP) 22214573.2

(51) Int. Cl. H05B 6/78; B01D 11/04; H05B 6/64; H05B 6/76

(52) U.S. Cl. CPC H05B 6/78; B01D 11/0419; H05B 6/6402; H05B 6/6408; H05B 6/76

(57) ABSTRACT

A microwave apparatus for extracting volatiles or liquids from an organic material by gravimetry, including:
(a) a microwave unit having an inlet opening and an outlet opening for the organic material
(b) at least one belt conveyor for conveying the organic material from a loading area through the microwave unit to an unloading area
   where the belt conveyor includes a belt having at its upper side upper face transversal partitions which define, between them, extraction zones having essentially a planar surface and comprising draining holes,
   where each transversal partitions have passing through it, a traversal chamber in which is accommodated a bar extending along more than the half of the transversal partition length and more than the half of the height of the transversal partitions,
   where the bar includes one rigid central core comprising a rigid, electrical conductor material.

### TECHNICAL FIELD

The present invention relates to the field of extraction of natural organic compounds from biomass by dielectric heating. More particularly, it concerns microwaves extraction processes using belt conveyors.

### BACKGROUND

Extraction of valuable compounds in liquid or vapor forms can be done by several extraction modes. Solvent-free continuous microwave assisted extraction has shown to be particularly advantageous due to the absence of solvent and quality of the extracts obtained.

In order to implement a continuous treatment of raw materials, microwave devices are usually open at an inlet side and an outlet side. The strategy commonly used to reduce leak of microwaves is microwave reflectors, mesh flaps or water jackets. Another drawback of open microwave is the leakage of volatiles that could impact the extraction yield and the quality of work of the operators.

Existing belt conveyors do not participate in reduction of leaking of volatiles or microwaves and improving in that way the yield of extraction and safety, conditions of work of operators

Belt conveyors are essential for continuous microwave extraction because the conveyor belt not only transports the raw material but is also the place of treatment of the raw material. Consequently, the conveyor belt should retain the raw material and allow the release of the liquids extracted. The existing conveyor belts have disadvantages as to the extraction of liquids and or vapor to different biomasses for obtaining food grade quality extracts. Indeed, existing conveyor belts do not have adapted structure to collect the liquids and retain the biomass.

In addition, cleaning and cross contamination between batches can also be an issue with classical conveyor belts due to the material used that could be permeable or absorb liquids, volatiles such as for example cement and graphite powder or, due to its structure that could be complicated to clean. Any of these reasons could generate microbiological risks or cross contaminations between batches.

Stability of the material when exposed to extreme conditions, typically repeated exposures to acidic or basic environment at high temperatures reduce drastically the duration of life of existing conveyor belts.

Existing conveyor belts are not adapted to continuous microwave extraction. Indeed, some issue cannot be observed for batch treatment because the treatment will not last e.g., during 7 hours in a row. Typically, some conveyor belts recommended for microwave extraction have been observed to generate electrical arcs or hot spots at very high temperatures due to the material used. Electrical arcs are considered as very dangerous on industrial facilities due to explosion risks and hot spot generating burning point within the biomass treated reduce drastically the extraction yield of the microwave notably by generating burning notes in the extracts.

The purpose of the invention is to provide an improved belt conveyor arrangement, for the MW extraction of organic material.

This object is achieved by means of the features of the independent claims. The dependent claims develop further the central idea of the invention.

An aspect relates to a microwave apparatus for extracting volatiles or liquids from an organic material by gravimetry, comprising
(a) a microwave unit having an inlet opening and an outlet opening for the organic material
(b) at least one belt conveyor for conveying the organic material from a loading area through the microwave unit to an unloading area
   wherein the belt conveyor comprises a belt having at its upper side upper face transversal partitions which define, between them, extraction zones having essentially a planar surface and comprising draining holes,
      wherein each transversal partitions have passing through it, an traversal chamber in which is accommodated a bar extending along more than the half of the transversal partition length and more than the half of the height of the transversal partitions,
      wherein the bar comprise one rigid central core that may be embedded in a preferably elastic outer layer from a MW transparent material, the rigid central core comprising a rigid, electrical conductor material.

The outer layer and/or at least the extraction zone of the conveyor belt may comprise a material that has one, more or all of the following characteristics:
a dielectric loss tangent lower than 0.01,
a dielectric constant lower than 4 and
a heat resistance up to 300° C.

The draining holes may be pores with an average diameter (d) of 0.001 to 30 millimeters, preferably, 0.01 to 20 mm.

The ratio of the distance (dp) between two transverse partitions and the length (D) between the inlet opening and the outlet opening of the microwave unit is of between 1 and 0.003.

The ratio h/H of the height (h) of the transversal partition and the height (H) of the distance between the upper face of the extraction zones and the upper border of the inlet opening and/or the outlet opening is between 0.99 to 0.2.

The longitudinal edges (L) comprise semi rigid or rigid slats arranged between the partitions.

The semi rigid or rigid slats may be formed from a material having a dielectric loss tangent lower than 0.01, a dielectric constant lower than 4 and a heat resistance until 300° C.

The outer layer may comprise a material having one, more or all of the following characteristics:
a maximum continuous working (service temperature from 20,000 hr. measured with the test method ISO 2578) up to 155° C., preferably up to 260° C., and/or
a thermal conductivity lower than 1 W/m-K, preferably less than about 0.50 W/m-K and/or
a Solvent resistance very good (ASTM D543), preferably equal to excellent, and/or
a Water absorption lower than 0.03% (ASTM D570), preferably equal to 0.0001% and/or
Coefficient of friction (ASTM D3702) lower than 0.4, preferably equal or lower than 0.1.

The rigid central core may be made from an electrically conductive material such as copper, steel, aluminum, lead, tin, zinc, brass, gold or silver.

A further aspect relates to a method of extracting liquid composition and/or volatile from an organic material, comprising the steps of using the apparatus as defined above.

The method may comprise the step of conveying, by the at least one belt conveyor, the organic material from a loading area outside the microwave unit to the inlet opening, then through the microwave unit to the outlet opening and then to an unloading area outside the microwave unit.

The method may comprise the step of draining, by the one or preferably the plurality of draining holes, the extracted liquid composition and/or volatile.

The method may comprise the step of heating the organic material. The heating may be dielectric heating.

### SUMMARY OF THE INVENTION

Further advantages, object and features of the invention will now be explained with reference to the figures of the enclosed drawings.

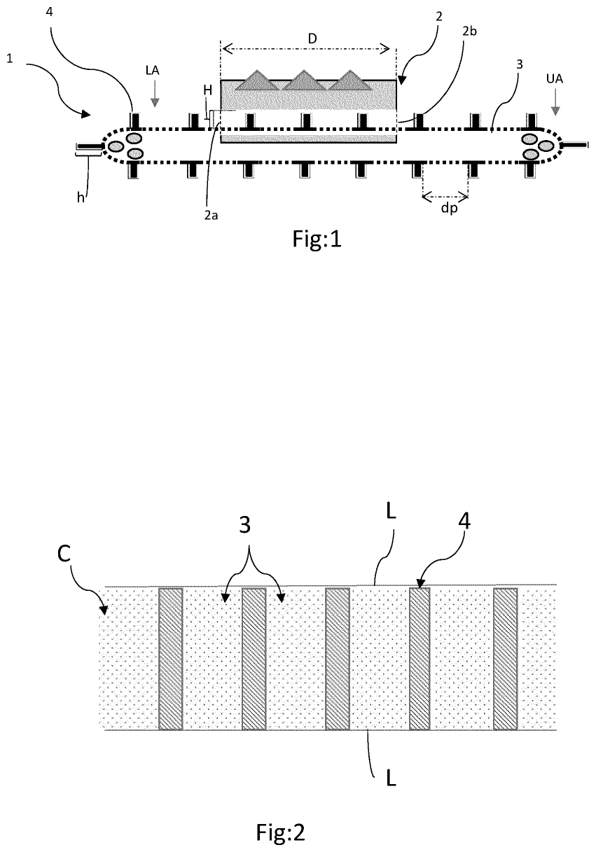

FIG. 1 shows a cut side view of a microwave extraction apparatus with belt conveyor according to the invention,

FIG. 2 shows a top view of a conveyor belt according to the invention.

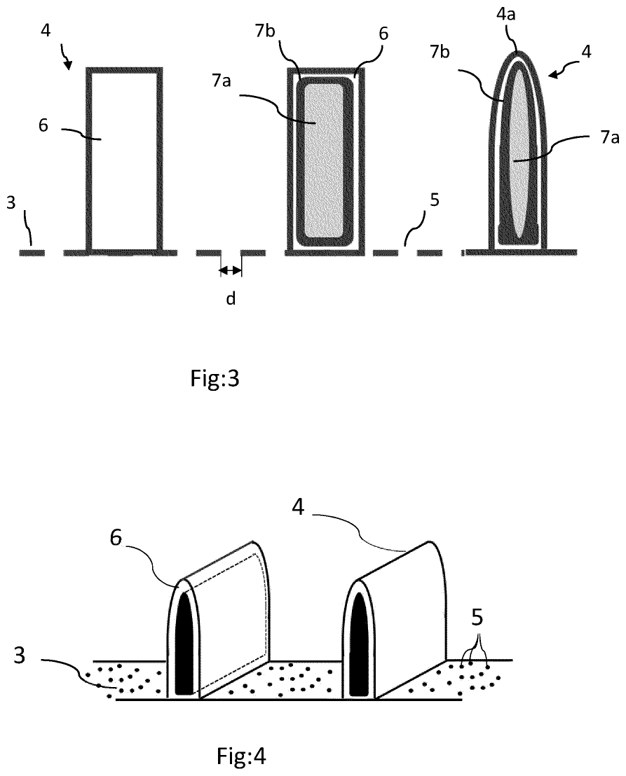

FIG. 3 shows cut side views of different partitions of a conveyor belt according to the invention,

FIG. 4 shows a perspective view of a conveyor belt with partitions according to the invention,

FIG. 5 shows an embodiment in which slats are arranged parallel to the edges of the conveyor belt, and

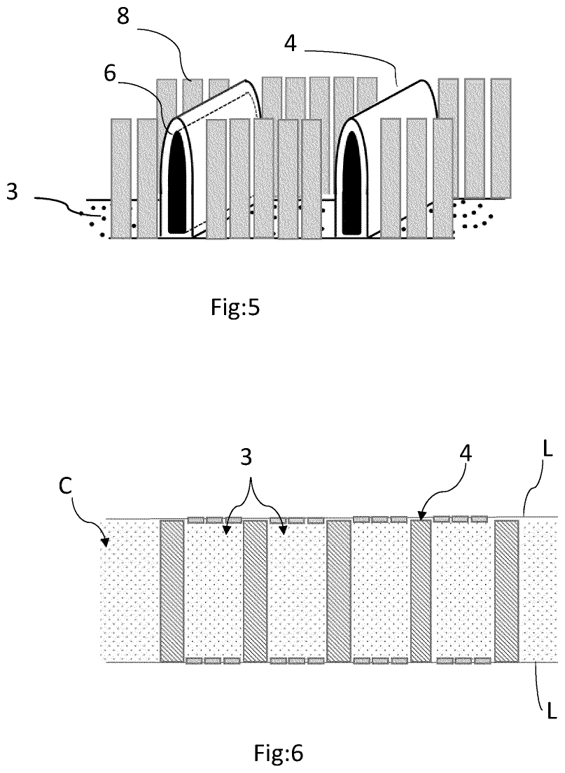

FIG. 6 is a perspective view of the embodiment of FIG. 5.

### DESCRIPTION OF THE INVENTION

FIG. 1 shows a microwave extraction apparatus for extracting organic material supplied into and out of a microwave cavity 2. The organic material is transported by a belt conveyor 1 entering the microwave cavity 2 at an inlet opening 2a and leaving the microwave cavity at an outlet opening 2b.

The organic material may be loaded onto the upper side of the belt conveyor 2 at a loading area LA, upfront the inlet opening 2a, and may be discharged from the upper side of the belt at a unloading area UA downstream the outlet opening 2b.

On the upper (outer side) of the belt a plurality of preferably equally spaced partitions 4 are arranged in parallel and in a right angle to the side edges L of the conveyor belt, thus defining extracting zones 3 for organic material between them.

As will be explained later, the partitions 4 are arranged to (mechanically) define a space for holding and separating the organic material. They are also arranged, by comprising an electrically conducting material, to cooperate with the inlet and outlet opening of the MW cavity (by closing them when passing through, thus reducing MW leakage. Furthermore, their material design is also chosen in order to positively contribute to the MW distribution in the MW cavity and the heating of the organic material and thus the extraction thereof.

The microwave cavity 2 is provided with one or microwave generators preferably arranged above the belt conveyor 2 within the microwave cavity 2.

The microwave cavity has a length D.

The clearance between the upper side of the belt (outside the partitions 4) and the upper edge of the typically rectangular inlet opening 2a is designated with H.

The height of the partitions, measured from the upper side of the belt, is designated with h.

The length of an extraction area, measured between facing sides of the partitions 4, is designated with dp.

A microwave apparatus for extracting volatiles or liquids from an organic material thus may comprise:
(a) a microwave unit (cavity) 2 having an inlet opening 2a and an outlet opening 2b for the organic material
(b) means for introducing the organic material into the apparatus at a loading area LA.
(c) means for removing the organic material from an unloading area UA;
(d) at least one belt conveyor 1 for conveying the organic material from the loading area LA through the microwave unit to the unloading area UA.

The belt conveyor 1 has a conveyor belt comprising two parallel longitudinal edges L and a central area C having essentially a planar surface on the lower face of the conveyor belt. On the upper face transversal partitions 4 extend traversing from one longitudinal edge L to the other. Thus, the upper surface of the belt is divided in several extraction zones 3 arranged for accommodating organic material to be extracted. The extraction zones 3 have an essentially a planar surface. In order to allow for a draining of (extracted) liquid compositions, the extraction zones 3 have one or preferably more draining openings. These draining openings maybe e.g., pores 5. The pores 5 may have be round or rectangular (the extraction zones thus having a grid structure). They may present an average diameter (d) of 0.001 to 30 millimeters, preferably, 0.01 to 20 mm.

As can be best seen in FIGS. 3 and 4, the partitions 4 may be formed as a double-layer sleeve, wherein the side walls of the sleeve are not connected leaving a tube-like chamber (channel) 6. The sleeve of the partitions 4 may be made from the same material as the belt. Preferably this material is microwave transparent. The sleeves may be formed continuously with the belt material, or maybe a separate element connected, at the bottom of the sleeves, to the flat belt material.

At the bottom of the partitions 4 the side walls of the sleeves are typically distanced. Typically, the sleave side walls are made from one continuous material. Thus, the cross-section of each partition may taper towards the peak of the partition 4. The sleave material typically is flexible or soft material or rigid material. It does not have openings or pores. It may be single layer or multilayer material.

The traversal channel defined by the sleave of the partitions 4 accommodates a preferably rigid insert which may be a rigid bar 7. The bar 7 may extend along more than the half of the transversal partition length and more than the half of the height of the transversal partitions.

The bar 7 may be made from a single, preferably rigid material, or maybe a compound bar 7 comprised of at least two different and distinctly arranged materials. In case of a compound bar, at least one material is rigid.

In the preferred embodiment, the bar 7 comprises one rigid central core 7a that may be embedded in a preferably elastic outer layer 7b. Preferably, the rigid central core 7 is made from a rigid, electrical conductor material. Preferably the outer layer 7b entirely covers the core 7a apart from the base of the core.

The sleeve is preferably closed also at its bottom, such that the bar can be loosely inserted. The side walls of the sleeve preferably are not connected to the bar. Alternatively, the bar may be connected (fixed in position relative) to the sleeve of the partition.

The elastic outer layer 7b and/or the extraction zones 3 of the conveyor belt may be made from a material that has one or more of, preferably all the following characteristics:
a dielectric loss tangent lower than 0.01, preferably lower than 0.005, preferably less than 0.001.
a dielectric constant lower than 4, preferably lower than 3.3, preferably less than about 2.1, and
a heat resistance until 300° C., preferably until 200° C., typically until 150° C.

The conveyor belt dimensions are adapted to the microwave oven in the way that the conveyor can convey raw materials at least from the loading area to the unloaded area through the microwave unit.

Typically, the conveyor belt has a width from 8 cm to 1.5 m preferably 10 cm to 1 m more preferably 15 cm and 0.8 m.

The height h of the transversal partition 4 is adapted to the microwave unit. Typically, in relative terms, the height h of the transversal partition 4 is slightly lower than the height H of the distance between the upper face of the extraction zones 3 and the upper edge of the inlet opening 2a and/or the outlet opening 2b. The ratio h/H is between 0.99 to 0.2, preferably 0.8 to 0.5.

In absolute terms, the difference between the height h of the transversal partition 4 over the height H of the distance between the upper face of the extraction zones 3 and the upper (typically horizontal) edge of the inlet opening 2a and/or the outlet opening 2b is preferably between 2 cm to 0.2 cm, more preferably between 1 cm and 0.3 cm, 1 mm to 5 mm; or 1.5 to 2 mm.

Advantageously, the transversal partition 4 has a height h of between 1 cm and 20 cm preferably between 2 and 15 cm, more preferably between 3 and 10 cm or 4 and 9 cm or 5 and 7 cm.

In an embodiment, each partition has a bar with rigid core 7a. In other embodiments, only every n-th partition, e.g., every other partition, has such bar. The rigid central core 7a of the transversal partition 4 may have a thickness of between 0.5 and 15 mm, preferably 1 mm and 5 mm, typically of 2 mm.

The elastic outer layer of the transversal partition 4 may have a thickness of 0.01 and 2 cm, preferably between 0.1 and 1 cm, even more preferably 0.2 and 0.9 cm.

The outer layer 7b may be coated onto the rigid core 7a.

Advantageously, the spacing of transversal partitions 4 is adapted to the dimensions (length) of the microwave unit. Typically, to reduce substantially the lost of volatiles and the leakage in microwave radiations, the ratio of the distance dp between two transversal partitions 4 and the length D between the inlet opening 2a and the outlet opening 2b is lower than or equal to 1, preferably lower than or equal to 0.8, 0.7, 0.5 or 0.4.

Typically, the ratio dp/D is of between 1 and 0,003, preferably 0.8 of 0.03 more preferably, 0.6 and 0.05 or 0.5 and 0.06 or 0.5 and 0.06.

According to one embodiment the extraction zones 3 comprises pores at least on its central area, preferably all the extraction zones 3 comprise pores.

More preferably the extraction zone 3 is made from a woven material or made by 3D printing or molded. It may have a grid structure.

Advantageously the transversal partitions 4, especially as to the sleeve material defining the chamber, do not comprise pores.

As used herein, “dielectric constant” refers to the relative electrical permittivity (Er) of a material. Unless otherwise specified, the term “dielectric constant” refers to the ratio of the permittivity of each material to the permittivity of vacuum. It is understood that the relative electrical permittivity (dimensionless) may exhibit frequency and temperature-dependence. In this invention, “dielectric constant” refers to the values taken at 20° C. and 1,000 Hz.

Dielectric loss tangent refers to a tangent value (tan(δ)) of the dielectric-loss angle (δ). Thus, “dielectric-loss angle” refers to a ratio of the imaginary part (ε″) of the dielectric permittivity to the real part (ε′) of the dielectric permittivity of a material. In addition, dielectric loss tangent refers to a parameter of a dielectric material that quantifies its inherent dissipation of electromagnetic energy into heat. Here, the so-called dielectric constant tangent refers to a value measured based on the method described in ASTM D150 [Ed 2018] at a frequency of 1 MHz and 25° C.

Typically, the elastic outer layer 7b and at least the extraction zone 3 of the conveyor belt 1 comprise or are made from a material that has dielectric loss tangent lower than 0.01, preferably lower than 0.005, preferably less than 0.001.

Typically, the outer layer 7b and at least the extraction zone 3 of the conveyor belt 1 comprise a material that has a dielectric constant lower than 4, preferably lower than 3.3, preferably less than about 2.1.

Advantageously, Teflon™ PTFE, FEP, and PFA fluoropolymers have suitable dielectric properties: a very low dielectric constant (relative permittivity) of 2.1 over a wide frequency range from 100 Hz to 50 GHz.

Another blended polymer prepared from PEEK and PTFE (PEEK/PTFE-5) has a dielectric constant of 3.21 and dielectric loss tangent of 6.00×10-3 at 10 KHz. Other suitable materials are e.g., thermosetting or thermoplastic materials. Suitable materials are polymers such as e.g., 1,2-polybutadiene (PBD, 1,2-polybutadiene), polyisoprene, polybutadiene-polyisoprene copolymers, polyetherimide (PEI, polyetherimide), polytetra Fluoropolymers such as fluoroethylene (PTFE, polytetrafluoroethylene), polyimide, polyetheretherketone (PEEK, polyetheretherketone), polyamidimide, polyethylene terephthalate (PET, polyethylene terephthalate), Polyethylene naphtholate, polycyclohexylene terephthalate, polybutadiene-polyisoprene copolymers, polyphenylene ethers, alkylated polyphenylene ethers polymers based on polyphenylene ethers) or combinations comprising one or more of the foregoing. Combinations of high and low polarity may be used, including epoxy and poly(phenylene ether), epoxy and poly(ether imide), cyanate Non-limiting examples including esters and poly(phenylene ether) {cyanate ester and poly(phenylene ether)} and 1,2-polybutadiene and polyethylene may be used.

The conveyor belt material is particularly suitable for microwave ovens and resist to very high temperature. Typically, the conveyor belt material is particularly suitable for microwaves having frequency within the range of between 0.3 to 300 GHz, preferably 0.5 to 5.2 GHz; 0.8 to 3 GHz; 0.9 to 2.5 GHz.

The term “heat resistance” refers to the ability of a material to withstand certain thermal conditions, i.e., heat transfer or temperature cycles, without physical or chemical changes. As used herein, it is understood that the heat resistance refers to a property in which there is no significant occurrence of melting, deformation, or blisters of a material. The temperature limits being the temperature at which the material property starts to change due to the temperature applied at atmospheric pressure.

Typically, the elastic outer layer 7b and at least the extraction zone 3 of the conveyor belt 1 comprise or are made from a material that has a heat resistance until 300° C. at atmospheric pressure.

For example, Teflon®, Tefzel®, Neoflon®, Polyflon® and Hyflon® fluoropolymers are extremely stable at high temperatures; Polytetrafluoroethylene (PTFE), Poly (ether ketone) (PEEK) and Perfluoro alkoxy alkanes (PFA) can be used continuously at 260° C. (500° F.), FEP at 205° C. (401° F.), and ETFE at 155° C. (311° F.) at atmospheric pressure.

Two critical factors used to describe the dielectric properties affecting the performance of a material are the dielectric constant (so-called the relative permittivity or εᵣ) and the loss tangent (also referred to as the dissipation factor). The relative permittivity refers to the ratio of the permittivity (ε) of the material to the permittivity (ε₀) of vacuum. Here, this term measures the ability of the material to store energy when applied an electric filed. Thus, this amount is related to the properties like polarization or capacitance. The loss tangent quantifies the amount of energy lost due to varying electric field through the material. The energy lost tend to increase with increases in frequency. Thus, this term denotes the sum of intrinsic and extrinsic dielectric losses.

As used herein, the term “dielectric material” is defined as any material with dielectric constant having a positive real part ¿′. In general, the term “dielectric material” is denoted as an electrical insulator material or a composite of different materials that can maintain an electric field with minimal power dissipation in the form of heat. By definition, “dielectric material” refers to the material that have a lower electrical mobility to be polarized when subjected to an electric field.

Relative Permittivity: As used herein, the term “relative permittivity” refers to the ability of a dielectric material subjected to an electric field to become polarized. Herein the term describes the ratio of the permittivity of it's the material to the permittivity of free space. Thus, the term so-called relative complex permittivity is denoted as a complex number which is related to a real and imaginary parts that exhibits temperature-frequency dependence as shown in Eq. 2.

$${ε}_{r} = \frac{ε}{{ε}_{0}} = {ε}^{′} - j {ε}^{′′} \qquad Eq . 2$$

where: εᵣ=relative permittivity, ε=measured permittivity, ε₀=electrical permittivity of vacuum (8.8542×10″12 F/m), ε′=real part of the permittivity, and ε″=imaginary part of the permittivity. By definition, a vacuum has a relative permittivity of 1, whereas water has a relativity permittivity of 80.1 (at 20° C.) and an organic coating typically has a relative permittivity of 3-8. Generally, the term “high permittivity” refers to a material having a relative permittivity of at least 3.3. Herein, the term “lower permittivity” refers to a material having a relative permittivity lower than 3.3.

The maximum continuous working (service temperature from 20,000 hr. measured with the test method ISO 2578) preferably is up to 155° C., preferably up to 260° C.

Reference to water absorption values refer to those values obtained using ASTM D570-98.

Typically, the elastic outer layer 7b comprises a material having a water absorption lower than 0.03%, preferably equal to 0.0001%.

Reference to excellent solvent resistance or very good solvent resistance refers to the evaluation “excellent” or “very good” obtained when assessing the resistance of the material to solvent according to the guidelines ASTM D543.

Coefficient of friction values are obtained by using the ASTM D3702-94 specifications. Typically, the elastic outer layer 7b comprises a material having a coefficient of friction lower than 0.4, preferably equal or lower than 0.1.

The thermal conductivity refers to a property of a material describing the relative ability of the material to transfer heat. Preferably the elastic outer layer 7b comprises a material having a thermal conductivity lower than 1 W/m-K, preferably less than about 0.50 W/m-K. In one example, an unreinforced polyetheretherketone (PEEK) has a thermal conductivity of about 0.25 W/m-K.

Other materials used in the catheter can comprise formulations or blends of polymers that include, but are not limited to PTFE, polyethylene terephthalate (PET), or PEBAX. PTFE (polytetrafluoroethylene) is a fluoropolymer which has high thermal stability (up to 260° C.), is chemically inert, has a very low dielectric constant, a very low surface friction and is inherently flame retardant. A range of homo and co-fluoropolymers are commercialized under such names as Teflon®, Tefzel® Neoflon®, Polyflon® and Hyflon®.

In general, the term “electrical conductor” or “electrically conductive material” refers to any suitable material, or composite of different materials, which allows the flow of electric charges through it. By definition, “electrical conductor” refers to materials that have higher electrical mobility of free electrons that allows electric currents to pass through it. Typically, the electrical conductor material is a metal, preferably selected among copper, steel, aluminum, lead tin, zinc, brass, gold, silver or a mix thereof.

Advantageously, the electrical conductor material is a stainless steel such as AISI 304, AISI 304L, AISI 316, AISI 316L, AISI 430 or ASTM A564.

Preferably the conveyor belt and the elastic sleeve are made of any of the following polymers, such as, but not limited to, fluoropolymers; or polyether ketone; or polyolefin or a mix thereof.

The fluoropolymers may be at least one of fluorinated homopolymers, such as, but not limited to, polytetrafluoroethylene (PTFE), polychlorotrifluoroethylene (PCTFE), ethylene-tetrafluoroethylene (ETFE), polyvinyl fluoride (PVF) or perfluoro alkoxy (PFA), ethylene-tetrafluoroethylene (ETFE), polyvinyl fluoride (PVF) or perfluoro alkoxy (PFA); or fluorinated copolymers, such as copolymerization of tetrafluoroethylene (FED), or tetrafluoroethylene (TFE), or vinylidene fluoride (VDF), or vinyl fluoride (VF) or chlorotrifluoroethylene (CTFE) and a monomer or a mix thereof. The fluoropolymers may be also selected from at least one, but not limited to, polyvinylidene fluoride (PVDF), tetrafluoroethylene-hexafluoropropylene (FEP), hexafluoropropylene (HFP) and perfluoro (propyl vinyl ether) (PPVE) or a mix thereof.

The polyether ketone may be at least one, but not limited to, of polyether ketone (PEK), polyether ether ketone (PEEK), and polyetherketoneketone (PEKK) or a mix thereof. The polyether ketone may be a copolymer, but not limited to, such as PEK/PEEK, PEEK/PES (polyether sulphone), PEK/PES or a mix thereof.

The polyolefin may be at least one, but not limited to, of polypropylene (PP), polyethylene (PE), olefin co-block polymer (OBC), polyolefin elastomer (POE), polyethylene co-vinyl acetate (EVA), polybutene (PB), and polyisobutylene (PIB) or a mix thereof.

According to one embodiment, shown in FIGS. 5 and 6, the longitudinal edges L are provided with one or more slats 8 preferably semi rigid or rigid slats 8, arranged between the partitions 4.

More than one slat can be provided on each side of each extraction zone, preferably with a gap between two consecutive slats.

Advantageously, the height of the slats 8 is between 0.25 to 3 time the height of the partitions, preferably 0.5 to 2, more preferably between 0.8 and 1.5. The slats, arranged between the partitions, limit the escape of raw materials without limiting the flux of the liquid extracted from the raw material. This embodiment is particularly advantageous for treating seeds or berries.

Preferably, the semi rigid or rigid slats 8 are made from a material having a dielectric loss tangent lower than 0.01, a dielectric constant lower than 4 and a heat resistance until 300° C.

1. A microwave apparatus for extracting volatiles or liquids from an organic material by gravimetry, comprising:
(a) a microwave unit having an inlet opening and an outlet opening for the organic material;
(b) at least one belt conveyor for conveying the organic material from a loading area outside the microwave unit to the inlet opening, then through the microwave unit to the outlet opening and then to an unloading area outside the microwave unit,
wherein the belt conveyor comprises a belt having at its upper side upper, face transversal partitions which define, between them, extraction zones having essentially a planar surface and comprising at least one draining hole,
wherein each transversal partitions have passing through it, a traversal chamber in which is inserted a bar extending along more than half of the transversal partition length and more than half of the height of the transversal partitions, and
wherein the bar comprises one rigid central core comprising a rigid, electrical conductor material.

2. The microwave apparatus of claim 1, wherein the rigid central core is embedded in an outer layer from a microwave (MW) transparent material.

3. The microwave apparatus of claim 2, wherein the outer layer comprises a material that has one, more, or all of the following characteristics:
a dielectric loss tangent lower than 0.01,
a dielectric constant lower than 4, and
a heat resistance up to 300° C.

4. The microwave apparatus according to claim 2, wherein the outer layer comprises a material having one, more or all of the following characteristics:
a maximum continuous working (service temperature from 20,000 hr. measured with the test method ISO 2578) up to 155° C., and/or
a thermal conductivity lower than 1 W/m-K, and/or
a Solvent resistance very good (ASTM D543), and/or
a Water absorption lower than 0.03% (ASTM D570), and/or
a Coefficient of friction (ASTM D3702) lower than 0.4.

5. The microwave apparatus according to claim 1, wherein at least the extraction zone of the conveyor belt comprises a material that has one, more or all of the following characteristics:
a dielectric loss tangent lower than 0.01,
a dielectric constant lower than 4, and
a heat resistance up to 300° C.

6. The microwave apparatus according to claim 1, wherein the draining holes are pores with an average diameter (d) of 0.001 to 30 millimeters.

7. The microwave apparatus according to claim 1, wherein the ratio of the distance (dp) between two transverse partitions and the length (D) between the inlet opening and the outlet opening of the microwave unit is of between 1 and 0.003.

8. The microwave apparatus according to claim 1, wherein the ratio h/H of the height (h) of the transversal partition and the height (H) of the distance between the upper face of the extraction zones and the upper border of the inlet opening and/or the outlet opening is between 0.99 to 0.2.

9. The microwave apparatus according to claim 1, wherein the longitudinal edges (L) comprise semi rigid or rigid slats arranged between the partitions.

10. The microwave apparatus according to claim 1, wherein the semi rigid or rigid slats are in a material having a dielectric loss tangent lower than 0.01, a dielectric constant lower than 4 and a heat resistance until 300° C.

11. The microwave apparatus according to claim 1, wherein the rigid central core is made from an electrically conductive material.

12. The microwave apparatus according to claim 1, wherein the walls of the traversal chamber accommodating the bar are made from the same material as the belt in the extraction zones but are void of openings or pores.

13. A method of extracting liquid composition and/or volatile from an organic material, comprising the steps of using the microwave apparatus according to claim 1.

14. The method of claim 13, comprising the step of conveying, by the at least one belt conveyor, the organic material from a loading area outside the microwave unit to the inlet opening, then through the microwave unit to the outlet opening and then to an unloading area outside the microwave unit.

15. The method of claim 13, comprising the step of draining, by the at least one draining hole, the extracted liquid composition and/or volatile.

16. The method of any of claim 13, comprising the step of heating the organic material.

17. The microwave apparatus according to claim 4, wherein the outer layer comprises a material having a thermal conductivity less than about 0.50 W/m-K.

18. The microwave apparatus according to claim 4, wherein the outer layer comprises a material having a Solvent resistance equal to excellent.

19. The microwave apparatus according to claim 4, wherein the outer layer comprises a material having a Water absorption equal to 0.0001% (ASTM D570).

20. The microwave apparatus according to claim 4, wherein the outer layer comprises a material having a Coefficient of friction (ASTM D3702) equal or lower than 0.1.
